(19) United States
(12) Patent Application Publication
(10) Pub. No.: US 2022/0300873 A1
(43) Pub. Date: Sep. 22, 2022

(54) SYSTEM AND METHOD FOR INSTITUTIONAL RISK IDENTIFICATION USING AUTOMATED NEWS PROFILING AND RECOMMENDATION

(71) Applicant: JPMorgan Chase Bank, N.A., New York, NY (US)

(72) Inventors: Mahmoud Ahmed MAHFOUZ, London (GB); Brian O'TOOLE, Robbinsville, NJ (US); Danny SCHWARTZMAN, New York, NY (US); Armineh NOURBAKHSH, Pittsburgh, PA (US); Sameena SHAH, Scarsdale, NY (US)

(73) Assignee: JPMorgan Chase Bank, N.A., New York, NY (US)

(21) Appl. No.: 17/654,843

(22) Filed: Mar. 15, 2022

Related U.S. Application Data
(60) Provisional application No. 63/162,280, filed on Mar. 17, 2021.

(51) Int. Cl. G06Q 10/06; G06N 3/08

(52) U.S. Cl. CPC G06Q 10/0635; G06N 3/08

(57) ABSTRACT

Systems and methods for identifying institutional risks using automated news profiling and recommendations re news relevance are provided. The method includes: receiving textual information that relates to a potential risk; analyzing the received textual information to extract a trigger, an outcome, and an exposure vessel of the potential risk; retrieving news items from online news aggregators based on the extracted information; obtaining a metric that relates to a degree of relevance of each news item to the potential risk; and calibrating the metric based on user inputs. The metric may be obtained by using a Sentence-BERT neural network model in conjunction with a cosine similarity metric.

### CROSS-REFERENCE TO RELATED APPLICATIONS

This application claims priority from U.S. Provisional Patent Application No. 63/162,280, filed in the U.S. Patent and Trademark Office on Mar. 17, 2021, which is hereby incorporated by reference in its entirety.

### BACKGROUND

### 1. Field of the Disclosure

This technology generally relates to methods and systems for institutional identification, and more particularly, to methods and systems for identifying institutional risks using automated news profiling and recommendations re news relevance.

### 2. Background Information

Institutions around the world face an array of risks that affect their operations globally. These risks are not necessarily associated with their key functions but also cover other types of risks, such as operational risks associated with cyber security attacks. As an example, the COVID-19 pandemic was an unexpected risk that was not accounted for by governments and institutions around the world. The pandemic has highlighted the need for institutions to have a robust risk identification, qualification and assessment model that qualifies potential risks on a frequent basis.

Risk owners rely on multiple sources of information to identify, qualify, and assess risks. An important source of information is global news that is available via a vast array of news sources in many different languages. The sheer volume of events highlighted in the news globally and the variety of risks an institution faces necessitate an automated approach for identifying and assessing existing and new risks using news.

### SUMMARY

The present disclosure, through one or more of its various aspects, embodiments, and/or specific features or sub-components, provides, inter alia, various systems, servers, devices, methods, media, programs, and platforms for identifying institutional risks using automated news profiling and recommendations re news relevance.

According to an aspect of the present disclosure, a method for identifying institutional risks based on news information is provided. The method is implemented by at least one processor. The method includes: receiving, by the at least one processor, textual information that relates to a potential risk; analyzing, by the at least one processor, the received textual information; retrieving, by the at least one processor, at least one news item based on a result of the analyzing; obtaining, by the at least one processor, a metric that relates to a degree of relevance of the retrieved at least one news item to the potential risk; and calibrating, by the at least one processor, the obtained metric based on at least one input received from a user.

The analyzing may include extracting, from the received textual information, at least one from among a trigger that relates to the potential risk, an outcome that relates to the potential risk, and an exposure vessel that relates to the potential risk.

The analyzing may further include using a deep bidirectional long short term memory (bi-LSTM) neural network sequence prediction model for performing the extracting.

The method may further include: constructing a knowledge graph based on the extracted at least one from among the trigger, the outcome, and the exposure vessel; and transmitting the knowledge graph to the user. The at least one input may be received from the user after the knowledge graph has been transmitted to the user.

The retrieving may include searching for the at least one news item online by using at least one news aggregator. The at least one news aggregator may include at least one from among Google News and Global Database of Events, Language and Tone (GDELT).

The method may further include: after the retrieving of the at least one news item and before the obtaining of the metric, performing a preprocessing operation with respect to each of the at least one news item that includes at least one from among a news deduplication operation, a news source filtering operation, a language filtering operation, and an exposure vessel filtering operation.

The obtaining of the metric that relates to the degree of relevance to the potential risk may include: using a neural network model to calculate contextual embeddings of the at least one news item; and rank ordering the calculated contextual embeddings by using a cosine similarity metric.

The neural network model may include a Sentence-bidirectional encoder representation from transformers (Sentence-BERT) neural network.

The calibrating may include using a machine learning algorithm to dynamically adjust the metric based on inputs received from a plurality of users.

According to another aspect of the present disclosure, a computing apparatus for identifying institutional risks based on news information is provided. The computing apparatus includes a processor; a memory; and a communication interface coupled to each of the processor and the memory. The processor is configured to: receive, via the communication interface, textual information that relates to a potential risk; analyze the received textual information; retrieve at least one news item based on a result of the analysis; obtain a metric that relates to a degree of relevance of the retrieved at least one news item to the potential risk; and calibrate the obtained metric based on at least one input received from a user.

The processor may be further configured to extract, from the received textual information, at least one from among a trigger that relates to the potential risk, an outcome that relates to the potential risk, and an exposure vessel that relates to the potential risk.

The processor may be further configured to use a deep bidirectional long short term memory (hi-LSTM) neural network sequence prediction model for performing the extraction.

The processor may be further configured to: construct a knowledge graph based on the extracted at least one from among the trigger, the outcome, and the exposure vessel; and transmit, via the communication interface, the knowledge graph to the user. The at least one input may be received from the user after the knowledge graph has been transmitted to the user.

The processor may be further configured to search for the at least one news item online by using at least one news aggregator. The at least one news aggregator may include at least one from among Google News and Global Database of Events, Language and Tone (GDELT).

The processor may be further configured to: after the at least one news item has been retrieved and before the metric has been obtained, perform a preprocessing operation with respect to each of the at least one news item that includes at least one from among a news deduplication operation, a news source filtering operation, a language filtering operation, and an exposure vessel filtering operation.

The processor may be further configured to obtain the metric that relates to the degree of relevance to the potential risk by: using a neural network model to calculate contextual embeddings of the at least one news item; and rank ordering the calculated contextual embeddings by using a cosine similarity metric.

The neural network model may include a Sentence-bidirectional encoder representation from transformers (Sentence-BERT) neural network.

The processor may be further configured to perform the calibrating by using a machine learning algorithm to dynamically adjust the metric based on inputs received from a plurality of users.

According to yet another aspect of the present disclosure, a non-transitory computer readable storage medium storing instructions for identifying institutional risks based on news information is provided. The storage medium includes executable code which, when executed by a processor, causes the processor to: receive textual information that relates to a potential risk; analyze the received textual information; retrieve at least one news item based on a result of the analysis; obtain a metric that relates to a degree of relevance of the retrieved at least one news item to the potential risk; and calibrate the obtained metric based on at least one input received from a user.

When executed by the processor, the executable code may further cause the processor to extract, from the received textual information, at least one from among a trigger that relates to the potential risk, an outcome that relates to the potential risk, and an exposure vessel that relates to the potential risk.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for identifying institutional risks using automated news profiling and recommendations re news relevance.

FIG. 4 is a flowchart of an exemplary process for implementing a method for identifying institutional risks using automated news profiling and recommendations re news relevance.

FIG. 5 is a system architecture diagram for a system that implements a method for identifying institutional risks using automated news profiling and recommendations re news relevance, according to an exemplary embodiment.

FIG. 6 is an example of a knowledge graph that describes relationships between entities and is usable for visualizing risks, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

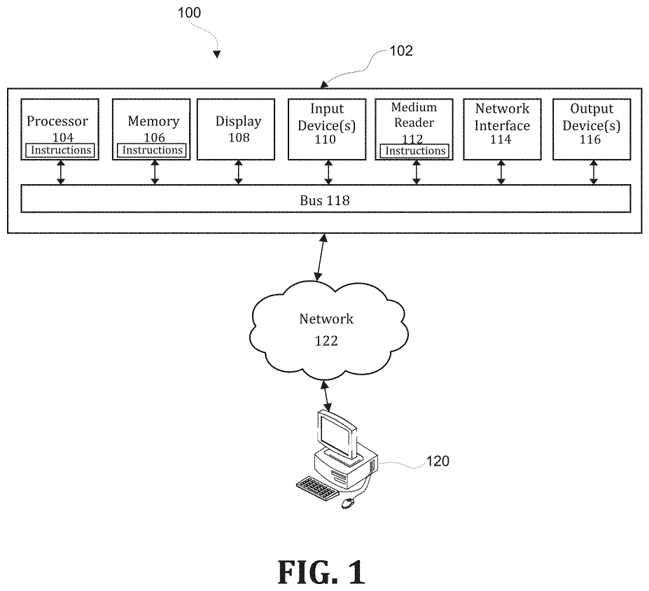

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art, The short-range network may include, for example, Bluetooth, Zigbee, infrared, near field communication, ultraband, or any combination thereof. Those skilled in the art appreciate that additional networks 122 which are known and understood may additionally or alternatively be used and that, the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for identifying institutional risks using automated news profiling and recommendations re news relevance.

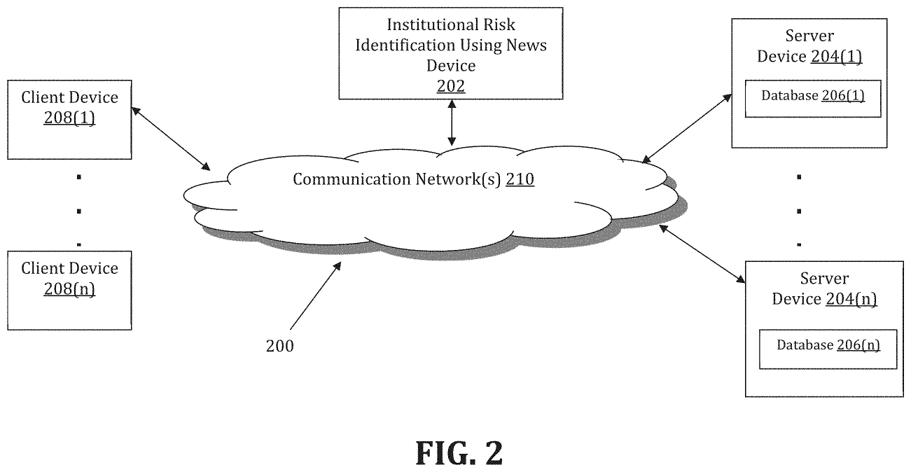

Referring to FIG. 2, a schematic of an exemplary network environment 200 for implementing a method for identifying institutional risks using automated news profiling and recommendations re news relevance is illustrated. In an exemplary embodiment, the method is executable on any networked computer platform, such as, for example, a personal computer (PC).

The method for identifying institutional risks using automated news profiling and recommendations re news relevance in a manner that is implementable in various computing platform environments may be implemented by an Institutional Risk Identification Using News (IRIUN) device 202. The IRIUN device 202 may be the same or similar to the computer system 102 as described with respect to FIG. 1. The IRIUN device 202 may store one or more applications that can include executable instructions that, when executed by the IRIUN device 202, cause the IRIUN device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IRIUN device 202 itself, may be located in virtual server(s) running in a cloud-based computing environment rather than being tied to one or more specific physical network computing devices. Also, the application(s) may be running in one or more virtual machines (VMs) executing on the IRIUN device 202. Additionally, in one or more embodiments of this technology, virtual machine(s) running on the IRIUN device 202 may be managed or supervised by a hypervisor.

In the network environment 200 of FIG. 2, the IRIUN device 202 is coupled to a plurality of server devices 204(1)-204(n) that hosts a plurality of databases 206(1)-206(n), and also to a plurality of client devices 208(1)-208(n) via communication network(s) 210. A communication interface of the IRIUN device 202, such as the network interface 114 of the computer system 102 of FIG. 1, operatively couples and communicates between the IRIUN device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IRIUN device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and IRIUN devices that efficiently implement a method for identifying institutional risks using automated news profiling and recommendations re news relevance.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IRIUN device 202 may be a standalone device or integrated with one or more other devices or apparatuses, such as one or more of the server devices 204(1)-204(n), for example. In one particular example, the IRIUN device 202 may include or be hosted by one of the server devices 204(1)-204(n), and other arrangements are also possible. Moreover, one or more of the devices of the IRIUN device 202 may be in a same or a different communication network including one or more public, private, or cloud networks, for example.

The plurality of server devices 204(1)-204(n) may be the same or similar the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IRIUN device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to news and news sources and institution-specific data that relates to risk relevance and recommendations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the IRIUN device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the IRIUN device 202 via the communication network(s) 210 in order to communicate user requests and information. The client devices 208(1)-208(n) may further include, among other features, a display device, such as a display screen or touch screen, and/or an input device, such as a keyboard, for example.

Although the exemplary network environment 200 with the IRIUN device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IRIUN device 202, the server devices 204(1)-204(n), or the client devices 208(1)-208(n), for example, may be configured to operate as virtual instances on the same physical machine. In other words, one or more of the IRIUN device 202, the server devices 204(1)-204(n), or the client devices 208(1)-208(n) may operate on the same physical device rather than as separate devices communicating through communication network(s) 210. Additionally, there may be more or fewer IRIUN devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

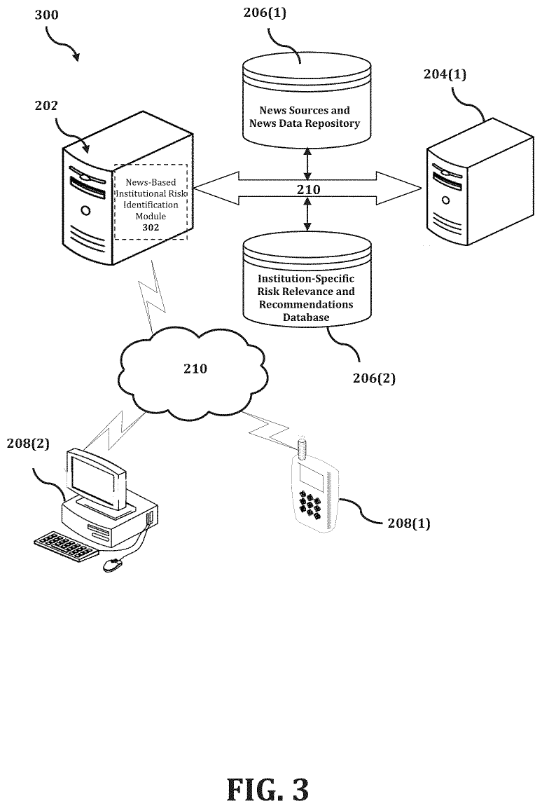

The IRIUN device 202 is described and shown in FIG. 3 as including a news-based institutional risk identification module 302, although it may include other fides, policies, modules, databases, or applications, for example. As will be described below, the news-based institutional risk identification module 302 is configured to implement a method for identifying institutional risks using automated news profiling and recommendations re news relevance in an automated, efficient, scalable, and reliable manner.

An exemplary process 300 for implementing a method for identifying institutional risks using automated news profiling and recommendations re news relevance by utilizing the network environment of FIG. 2 is shown as being executed in FIG. 3. Specifically, a first client device 208(1) and a second client device 208(2) are illustrated as being in communication with IRIUN device 202. In this regard, the first client device 208(1) and the second client device 208(2) may be “clients” of the IRIUN device 202 and are described herein as such. Nevertheless, it is to be known and understood that the first client device 208(1) and/or the second client device 208(2) need not necessarily be “clients” of the IRIUN device 202, or any entity described in association therewith herein. Any additional or alternative relationship may exist between either or both of the first client device 208(1) and the second client device 208(2) and the IRIUN device 202, or no relationship may exist.

Further, IRIUN device 202 is illustrated as being able to access a news sources and news data repository 206(1) and an institution-specific risk relevance and recommendations database 206(2). The news-based institutional risk identification module 302 may be configured to access these databases for implementing a method for identifying institutional risks using automated news profiling and recommendations re news relevance.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the IRIUN device 202 via broadband or cellular communication. Of course, these embodiments are merely exemplary and are not limiting or exhaustive.

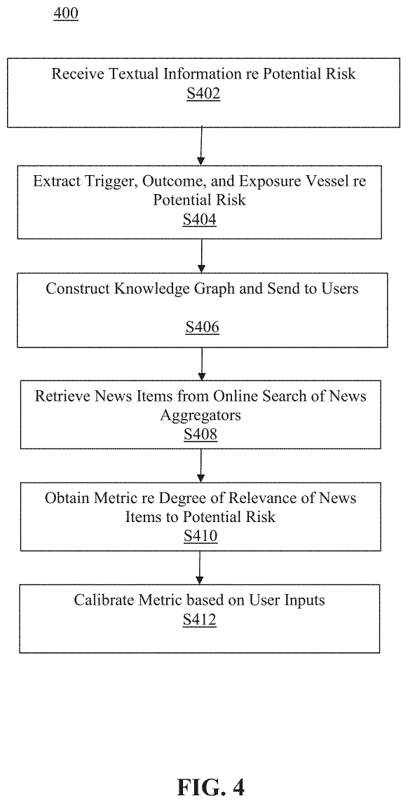

Upon being started, the news-based institutional risk identification module 302 executes a process for identifying institutional risks using automated news profiling and recommendations re news relevance. An exemplary process for identifying institutional risks using automated news profiling and recommendations re news relevance is generally indicated at flowchart 400 in FIG. 4.

In the process 400 of FIG. 4, at step S402, the news-based institutional risk identification module 302 receives textual information that relates to a potential risk, and at step S404, the news-based institutional risk identification module 302 analyzes the textual information. In an exemplary embodiment, the analysis includes extracting, from the textual information, a trigger that relates to the potential risk, an outcome that relates to the potential risk, and an exposure vessel that relates to the potential risk. For example, when the news-based institutional risk identification module 302 receives “cyber attacks targeting the retail banking business causing loss of customer data” as textual information that relates to a potential risk at step S402, then at step S404, the news-based institutional risk identification module 302 may extract “cyber attacks” as corresponding to the trigger of the risk, “the retail banking business” as the exposure vessel of the risk, and “causing loss of customer data” as the outcome of the risk.

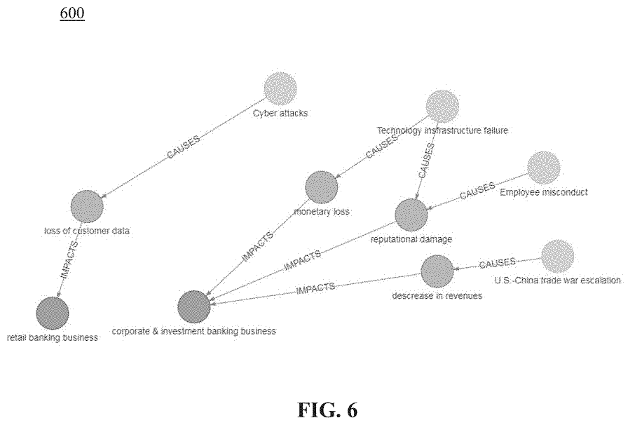

At step S406, the news-based institutional risk identification module 302 constructs a knowledge graph based on the extracted information and sends the knowledge graph to users that may be interested in risk identification and/or assessment. A knowledge graph formally represents semantics by describing entities and their relationships. In an exemplary embodiment, the knowledge graph is designed for visualizing risks faced by an institution and for performing reasoning over data, thereby assisting risk owners in understanding how several risks are related to each other and what are the key triggers of risk. Further disclosure in relation to knowledge graphs is provided below with respect to FIG. 6.

At step S408, the news-based institutional risk identification module 302 retrieves news items based on an online search of news aggregator sources. In an exemplary embodiment, the news aggregator sources may include one or both of Google News and Global Database of Events, Language and Tone (GDELT).

At step S410, the news-based institutional risk identification module 302 obtains a metric that indicates a degree of relevance of each retrieved news item with respect to the potential risk. In an exemplary embodiment, the metric may be obtained by using a neural network model together with a cosine similarity metric. For example, a Bidirectional Encoder Representations Transformers (BERT) model, and/or a variant thereof, such as the Sentence-BERT model, may be used to calculate contextual embeddings of sentences included in a particular news item, and the cosine similarity metric may then be applied to the contextual embeddings in order to determine a rank ordering thereof with respect to a relevance to the potential risk.

At step S412, the news-based institutional risk identification module 302 calibrates the obtained metric based on user inputs. In an exemplary embodiment, users that may have received the knowledge graph constructed in step S406 may provide feedback that relates to their own perceptions of how relevant a particular news item is to a potential risk, and the news-based institutional risk identification module 302 may apply a machine learning algorithm that uses such feedback as input in order to dynamically adjust the metric.

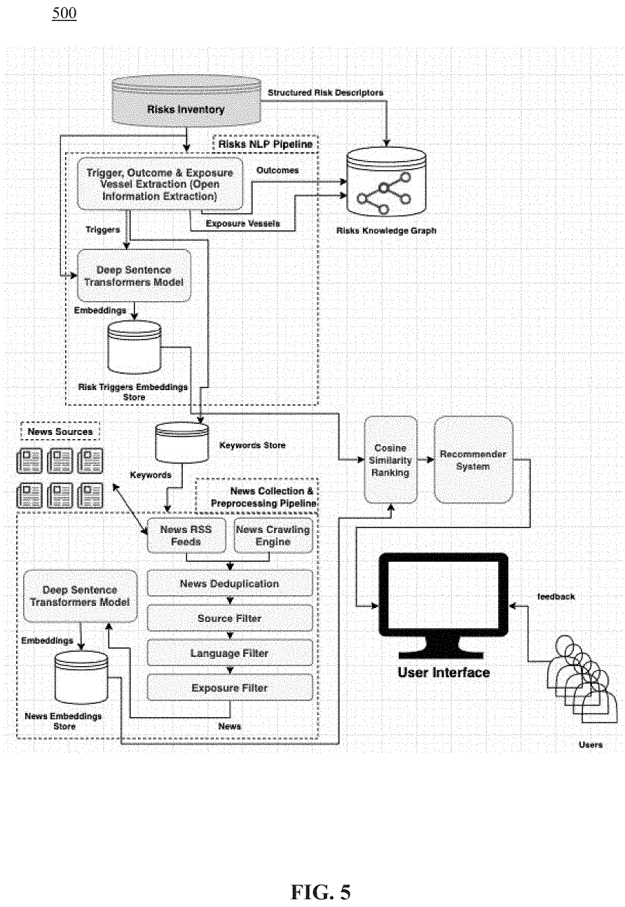

In an exemplary embodiment, a system and a method for identifying institutional risks using automated news profiling and recommendations re news relevance is designed to automatically match relevant news to risks identified by the institution. The system utilizes a neural embedding model known as Sentence-BERT (BERT=Bidirectional Encoder Representations from Transformers) to match the textual description of the text with global news. The system also implements a recommender system component to rank the news relevance for each user. FIG. 5 is a system architecture diagram 500 that illustrates a system for identifying institutional risks using automated news profiling and recommendations re news relevance, according to an exemplary embodiment

The COVID-19 pandemic was an unexpected risk that was not accounted for by governments and institutions around the world. It highlighted the need for institutions to have a robust risk identification, qualification and assessment model that qualifies potential risks on a more frequent basis (e.g. daily). Coupled with multi-lingual news from across the globe, an automated system for news profiling and recommendation is deemed to be an important step to augment the risk qualification process.

Risk owners rely on multiple sources of information to identify, qualify, and assess risks. An important source of information is global news from a vast array of news sources in many different languages. Given the variety and volume of the various drivers of risk, in an exemplary embodiment, a human-in-the loop AI system using natural processing (NLP) methods is provided. Recent advances in deep learning for NLP applications allow for dealing with multilingual texts. They also offer the ability to translate these texts, filter them, and rank them according to their relevance to the end user. The vast amount of events highlighted in the news globally and the variety of risks an institution faces necessitate an automated approach for identifying and assessing existing and new risks using news.

In an exemplary embodiment, the system relies on an assumption that the risks have been identified by risk owners with expertise in specific domains. The risk owners are responsible for identifying and qualifying the impact of specific risks on the institution. These risks are usually reviewed periodically (e.g. on a quarterly basis) and highlighted to the operating committee of the institution for determining methods to reduce and overcome the impact of these risks.

Open information extraction: In an exemplary embodiment, given a textual description of the risk, the system attempts to decompose the text to several components: 1) trigger; 2) outcome; and 3) exposure vessel. The trigger explains the root cause of the risk. The outcome describes the specific impact of the given risk. Finally, the exposure vessel describes the vessel the risk impacts.

Several approaches were tested to decompose the text into the three aforementioned categories. One of these is based on a deep bidirectional long short term memory (bi-LSTM) neural network sequence prediction model that was originally developed for supervised open information extraction. The model breaks a given sentence (e.g., the risk text) into the relationships they express. In particular, the model extracts a list of propositions, each composed of a single predicate and an arbitrary number of arguments.

As an example, consider the following risk: “cyber attacks targeting the retail banking business causing loss of customer data”. The model breaks the sentence into the following components: A first argument “cyber attacks” precedes a first verb “targeting,” which precedes a second argument “the retail banking business,” which is followed by a second verb “causing” and a third argument “loss of customer data.” In this example, the first argument maps to the trigger of the risk, which in this case is cyber attacks. The outcome and exposure vessel typically follow the first verb in the sentence. In this example, the retail banking business is the exposure vessel, and the argument after the second verb, loss of customer data, is the outcome.

It has been found that the risk text descriptions are often entered by risk owners using a common sentence structure intended to improve the readability of the risks. This significantly helps in the risk information extraction process, allowing for breaking down the sentences using heuristic rules around these causal expressions. For example, text before the word causing usually refers to the trigger.

Knowledge graph: Once the triggers, outcomes and exposure vessels are identified, the extracted information is used to construct a knowledge graph. A knowledge graph formally represents semantics by describing entities and their relationships. In an exemplary embodiment, the knowledge graph is designed for visualizing the risks faced by the institution and for performing reasoning over data. This is intended to help risk owners understand how several risks are related to each other, what are the key triggers of risk facing the institution, etc. The knowledge graph utilized the information from the above-described example with the nodes of the graph describing the triggers, outcomes and exposure vessels and the edges describing the relationship between the three categories. In an exemplary embodiment, a trigger causes a given outcome and the outcome impacts a given exposure vessel.

As an example, consider the following set of risks: 1) Cyber attacks targeting the retail banking business causing loss of customer data. 2) U.S.-China trade war escalation affecting the corporate and investment banking business causing a decrease in revenues. 3) Employee misconduct in the investment banking business causing a reputational damage. 4) Technology infrastructure failure in the corporate and investment banking business causing a reputational damage and/or monetary losses. Referring to FIG. 6, a knowledge graph 600 constructed using the above risks is illustrated.

News crawler and data preprocessing: In this component of the system, the trigger information is used to search for news online. In an exemplary embodiment, the system utilizes two news aggregators: (1) Google News and (2) Global Database of Events, Language and Tone (GDELT). Google News is an aggregation service developed by Google monitoring news from thousands of publishers, newspapers and magazines online. GDELT is a real-time open source database that monitors the world's broadcast, print and web news from a vast range of countries covering over 100 languages.

In an exemplary embodiment, a news web craw-le collects articles from Google News with the keyword based on the trigger identified for each risk. For GDELT, the system may use an open-source python API to retrieve multi-lingual news from across the globe associated with the risk trigger.

In an exemplary embodiment, once the articles are retrieved, an optional data preprocessing stage is included in the system for (1) news deduplication, (2) news source filtering, (3) language filtering and (4) exposure vessel filters. These pre-processing steps allow for a custom solution tailored to any risk owner.

Text embeddings and news relevance ranking: In an exemplary embodiment, at this stage of the system, the news for each risk are retrieved based on the trigger identified. This, however, returns a large amount of news, including many items that are not relevant to the risk itself. To help filter the news retrieved, a neural network model is used in conjunction with a cosine similarity metric to identify the top relevant news for each risk. The model used is based on a bidirectional encoder representation from transformers (BERT) neural network, which is usable for predicting masked works in a sentence. In an exemplary embodiment, the system uses Sentence-BERT (S-BERT), which is an extension of a model that was originally used to compute contextual sentence embeddings. These embeddings are dense vector representations for sentences, and the model is tuned specifically to produce meaningful sentence embeddings such that sentences with similar meanings are close in the vector space.

In an exemplary embodiment, S-BERT is used to compute the contextual embeddings of the risk text and the news title text. Once the contextual embeddings vector is obtained for each risk and news, the vectors are ranked according to the cosine similarity metric. Given two vectors, r∈ [symbol] and h∈ [symbol] , the cosine similarity metric is defined as:

$$\frac{r \cdot h}{‖ r ‖ ‖ h ‖} = \frac{{\sum }_{i = 1}^{n} {r}_{i} \cdot {h}_{i}}{\sqrt{{\sum }_{i = 1}^{n} {r}_{i}^{2}} \sqrt{{\sum }_{i = 1}^{n} {h}_{i}^{2}}}$$

Recommender system: In an exemplary embodiment, a relevance ranker identifies headlines that are semantically similar to a risk item, but this does not guarantee that the headlines will be relevant to the particular risk owner. As an example, an article that is ranked as highly relevant to reputational risk may be considered irrelevant by the risk owners, perhaps because it is referencing an old legal dispute, is related to a different business function, or has been misclassified by the system.

In an exemplary embodiment, in order to ensure that the system properly adjusts itself to user preferences, a recommender engine is provided for each particular risk owner. Traditionally, recommender engines fall into one of two categories: content personalization systems and product recommendation engines. Personalization systems use signals provided by user behavior to profile users and predict the content that the users will be most interested in. Reinforcement learning is a common method in this domain, with growing popularity in advertisement targeting. Product recommendation engines commonly use cross-user behavioral signals to come up with a join understanding of products and user profiles. The most common method in this group of systems is collaborative filtering.

While these two paradigms can be a source of inspiration, the systems and methods in accordance with exemplary embodiments disclosed herein differ from them in fundamental ways. In this aspect, risk recommendation is not approached as a personalization system, because the risk owners are bound by industry and enterprise standards rather than personal preferences. Conversely, product recommendation engines often rely on large-scale, cross-user signals, but these are not reliably available. To further complicate the landscape, news is a uniquely unstable product, because its semantic representation can shift rapidly over time. As an example, the term “Donald Trump” might have been considered largely irrelevant to enterprise risk in 2014, but the landscape would have shifted massively in 2015.

To address these challenges, in an exemplary embodiment, the recommender engine is designed as an online learning model. Online learning is a paradigm that allows Machine Learning models to dynamically adjust their parameters. In traditional Machine Learning, a static set of training examples is provided, based on which a model is trained to estimate optimal parameters. After the training stage, the model is deployed with the optimal parameters, which are no longer adjusted. This is commonly referred to as the inference stage. In contrast to traditional models, online learning models do not have separate training and inference stages, but continually learn from new examples provided by end users. The learning mechanism needs to be sufficiently responsive to user feedback, but not to the point that it renders the model unstable,

In an exemplary embodiment, each headline is represented as a vector of size 1024. Each risk item rᵢ is represented by a set of headlines {hᵢ⁽¹⁾, . . . , hᵢ⁽ⁿ⁾} that have passed the similarity filter. Online learning is approached as a real-time partitioning problem in which predictions are made regarding which headlines in this collection are relevant to rᵢ and which are not. In order o provide a venue for users to make corrections to the model's predictions, an interactive feedback mechanism is implemented, in order to allow users to tag each headline hᵢ^{(j)} as relevant or irrelevant to rᵢ. Each hᵢ^{(j)} is initialized with a confidence score of 1.0, and the score is continually calibrated based on user feedback.

In an exemplary embodiment, at each timestamp t, one of the following events might occur: 1) User might tag hᵢ^{(j)} as irrelevant. In this case, the confidence of hᵢ^{(j)} is adjusted to 0.0. 2) User might tag hᵢ^{(j)} as relevant. In this case, the confidence of is adjusted to 1.0. 3) User might tag another headline hᵢ^{(j′)} as irrelevant. In this case, the confidence of hᵢ^{(j)} is adjusted as

$${c}^{( i )} = φ ( {c}^{( i )} + \frac{{e}^{\frac{- {d ( j , {j}^{′} )}^{2}}{2 {σ}^{2}}}}{\sqrt{2 π} σ} ) ,$$

where φ is a bounded function such as sigmoid, and d(j, j′) represents the cartesian or cosine distance between hᵢ^{(f)} and hᵢ^{(j′)}. 4) User might tag another headline hᵢ^{(j′)} as relevant. In this case, the confidence of hᵢ^{(j)} is adjusted by

$${c}^{( i )} = φ ( {c}^{( i )} - \frac{{e}^{\frac{- {d ( j , {j}^{′} )}^{2}}{2 {σ}^{2}}}}{\sqrt{2 π} σ} ) ,$$

where φ is a bounded function such as sigmoid, and d(j,j′) represents the cartesian or cosine distance between hᵢ^{(j)} and hᵢ^{(j′)}.

At the beginning of the exercise, the distribution parameter σ is initialized as the expected value of the cartesian or cosine distance between any given pair of headlines (σ₀=E[d(x, x′)]; ∀x, x′∈{1, . . . n}; x≠x′), and subjected to exponential decay (i.e., σ(t)=σ₀e^{-λt} where λ is set using grid search). Confidence scores are continually adjusted by feedback and those remaining stable within a tolerance threshold ϵ after m steps are fixed against any further changes.

Any new headline that is added to the pool is assigned a confidence score of

$$ϕ ( {\sum }_{{k}^{′}} {e}^{\frac{- {d ( k , {k}^{′} )}^{2}}{2 {σ}^{2}}} ) ,$$

where d(k, k′) represents the cartesian or cosine distance between the new incoming headline hᵢ^{(k)} and existing headlines in the pool {hᵢ^{k′}}.

Accordingly, with this technology, an optimized process for identifying institutional risks using automated news profiling and recommendations re news relevance is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying institutional risks based on news information, the method being implemented by at least one processor, the method comprising:
receiving, by the at least one processor, textual information that relates to a potential risk;
analyzing, by the at least one processor, the received textual information;
retrieving, by the at least one processor, at least one news item based on a result of the analyzing;
obtaining, by the at least one processor, a metric that relates to a degree of relevance of the retrieved at least one news item to the potential risk; and
calibrating, by the at least one processor, the obtained metric based on at least one input received from a user.

2. The method of claim 1, wherein the analyzing comprises extracting, from the received textual information, at least one from among a trigger that relates to the potential risk, an outcome that relates to the potential risk, and an exposure vessel that relates to the potential risk.

3. The method of claim 2, wherein the analyzing further comprises using a deep bidirectional long short term memory (bi-LSTM) neural network sequence prediction model for performing the extracting.

4. The method of claim 2, further comprising:
constructing a knowledge graph based on the extracted at least one from among the trigger, the outcome, and the exposure vessel; and
transmitting the knowledge graph to the user,
wherein the at least one input is received from the user after the knowledge graph has been transmitted to the user.

5. The method of claim 1, wherein the retrieving comprises searching for the at least one news item online by using at least one news aggregator, and
wherein the at least one news aggregator includes at least one from among Google News and Global Database of Events, Language and Tone (GDELT).

6. The method of claim 1, further comprising:
after the retrieving of the at least one news item and before the obtaining of the metric, performing a preprocessing operation with respect to each of the at least one news item that includes at least one from among a news deduplication operation, a news source filtering operation, a language filtering operation, and an exposure vessel filtering operation.

7. The method of claim 1, wherein the obtaining of the metric that relates to the degree of relevance to the potential risk comprises:
using a neural network model to calculate contextual embeddings of the at least one news item; and
rank ordering the calculated contextual embeddings by using a cosine similarity metric.

8. The method of claim 7, wherein the neural network model includes a Sentence-bidirectional encoder representation from transformers (Sentence-BERT) neural network.

9. The method of claim 1, wherein the calibrating comprises using a machine learning algorithm to dynamically adjust the metric based on inputs received from a plurality of users.

10. A computing apparatus for identifying institutional risks based on news information, the computing apparatus comprising:
a processor;
a memory; and
a communication interface coupled to each of the processor and the memory,
wherein the processor is configured to:
receive, via the communication interface, textual information that relates to a potential risk;
analyze the received textual information;
retrieve at least one news item based on a result of the analysis;
obtain a metric that relates to a degree of relevance of the retrieved at least one news item to the potential risk; and
calibrate the obtained metric based on at least one input received from a user.

11. The computing apparatus of claim 10, wherein the processor is further configured to extract, from the received textual information, at least one from among a trigger that relates to the potential risk, an outcome that relates to the potential risk, and an exposure vessel that relates to the potential risk.

12. The computing apparatus of claim 11, wherein the processor is further configured to use a deep bidirectional long short term memory (bi-LSTM) neural network sequence prediction model for performing the extraction.

13. The computing apparatus of claim 11, wherein the processor is further configured to:
construct a knowledge graph based on the extracted at least one from among the trigger, the outcome, and the exposure vessel; and
transmit, via the communication interface, the knowledge graph to the user,
wherein the at least one input is received from the user after the knowledge graph has been transmitted to the user.

14. The computing apparatus of claim 10, wherein the processor is further configured to search for the at least one news item online by using at least one news aggregator, and
wherein the at least one news aggregator includes at least one from among Google News and Global Database of Events, Language and Tone (GDELT).

15. The computing apparatus of claim 10, wherein the processor is further configured to:
after the at least one news item has been retrieved and before the metric has been obtained, perform a preprocessing operation with respect to each of the at least one news item that includes at least one from among a news deduplication operation, a news source filtering operation, a language filtering operation, and an exposure vessel filtering operation.

16. The computing apparatus of claim 10, wherein the processor is further configured to obtain the metric that relates to the degree of relevance to the potential risk by:
using a neural network model to calculate contextual embeddings of the at least one news item; and
rank ordering the calculated contextual embeddings by using a cosine similarity metric.

17. The computing apparatus of claim 16, wherein the neural network model includes a Sentence-bidirectional encoder representation from transformers (Sentence-BERT) neural network.

18. The computing apparatus of claim 10, wherein the processor is further configured to perform the calibrating by using a machine learning algorithm to dynamically adjust the metric based on inputs received from a plurality of users.

19. A non-transitory computer readable storage medium storing instructions for identifying institutional risks based on news information, the storage medium comprising executable code which, when executed by a processor, causes the processor to:
receive textual information that relates to a potential risk;
analyze the received textual information;
retrieve at least one news item based on a result of the analysis;
obtain a metric that relates to a degree of relevance of the retrieved at least one news item to the potential risk; and
calibrate the obtained metric based on at least one input received from a user.

20. The storage medium of claim 19, wherein when executed by the processor, the executable code further causes the processor to extract, from the received textual information, at least one from among a trigger that relates to the potential risk, an outcome that relates to the potential risk, and an exposure vessel that relates to the potential risk.
